(19) United States
(12) Patent Application Publication
(10) Pub. No.: US 2025/0323340 A1
(43) Pub. Date: Oct. 16, 2025

(54) ELECTRICITY STORAGE APPARATUS AND VEHICLE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 18/976,985

(22) Filed: Dec. 11, 2024

(30) Foreign Application Priority Data
Apr. 10, 2024 (JP) 2024-063297

(51) Int. Cl. H01M 10/625; B60K 6/28; B60K 6/40; H01M 10/613; H01M 10/653; H01M 10/656; H01M 50/242; H01M 50/249

(52) U.S. Cl. CPC H01M 10/625; B60K 6/28; B60K 6/40; H01M 10/613; H01M 10/653; H01M 10/656; H01M 50/242; H01M 50/249; B60Y 2200/92; B60Y 2306/05; B60Y 2400/112; H01M 2220/20

(57) ABSTRACT

An electricity storage apparatus (a battery pack) includes a case (a LWR case and an UPR case), and an electricity storage element (battery stacks) and an electrical device (a battery device) that are housed in the case. The case is provided with a protection plate that protects the electrical device. The electricity storage apparatus further includes a cooling pipe that cools the electricity storage apparatus. The protection plate is disposed between at least a part of the cooling pipe (a device cooling portion) and the electrical device.

### CROSS-REFERENCE TO RELATED APPLICATION

This application claims priority to Japanese Patent Application No. 2024-063297 filed on Apr. 10, 2024, incorporated herein by reference in its entirety.

### BACKGROUND

### 1. Technical Field

The present disclosure relates to an electricity storage apparatus, and a vehicle including the electricity storage apparatus.

### 2. Description of Related Art

Japanese Unexamined Patent Application Publication No. 2022-128961 discloses a technique in which a stay is provided on a frame body of a battery case, and when a collision load is input to the stay due to a front collision or a rear collision, the stay is bent by the input collision load. The stay employed in the technique has a contour portion that deforms outward in the up-down direction relative to at least one of a front wall and a rear wall of the frame body of the battery case such that impact energy caused by the collision is absorbed by the deformation of the stay.

### SUMMARY

Not only an electricity storage element (battery) but also an electrical device, such as a junction box (J/B) or a control device, may be housed in a case (battery case) of an electricity storage apparatus. In JP 2022-128961 A, although protection of the electricity storage element is mentioned, protection of the electrical device is not mentioned. In addition, in JP 2022-128961 A, a device that cools the electricity storage apparatus is not mentioned. In the electricity storage apparatus provided with a protection member such as the stay described above, it is difficult to further provide a cooling pipe.

The present disclosure has been made to solve the problems described above, and an object thereof is to achieve both protection and cooling of an electricity storage apparatus.

According to an embodiment of the present disclosure, the following electricity storage apparatus is provided.

The electricity storage apparatus includes a case, and an electricity storage element and an electrical device that are housed in the case. The case is provided with a protection plate that protects the electrical device. The electricity storage apparatus further includes a cooling pipe that cools the electricity storage apparatus. The protection plate is disposed between at least a part of the cooling pipe and the electrical device.

The electrical device inside the case can be protected by providing the protection plate as described above. However, providing the protection plate may disadvantageously reduce the heat dissipation of the electrical device. In this regard, in the electricity storage apparatus, at least a part of the cooling pipe can exchange heat with the electrical device through the protection plate. This makes it possible to achieve both protection and cooling of the electricity storage apparatus (in particular, the electrical device inside the case).

The present disclosure makes it possible to achieve both protection and cooling of an electricity storage apparatus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a vehicle equipped with an electricity storage apparatus according to an embodiment of the present disclosure;

FIG. 2 is a diagram showing the configuration of the electricity storage apparatus according to the embodiment;

FIG. 3 is a diagram for describing a mode of attachment of a protection plate of the electricity storage apparatus according to the embodiment;

FIG. 4 is a sectional view taken along line IV-IV in FIG. 2;

FIG. 5 is a diagram for describing the actions and effects of the electricity storage apparatus according to the embodiment; and

FIG. 6 is a diagram showing a modification of a cooling pipe shown in FIG. 2.

### DETAILED DESCRIPTION OF EMBODIMENTS

An embodiment of the present disclosure will be described in detail with reference to the drawings. In the drawings, identical or equivalent parts are designated by the same reference signs, and repetitive description thereof will be omitted. In each drawing, for the directions of three axes (an X-axis, a Y-axis, and a Z-axis) perpendicular to each other, the direction indicated by an arrow is described with “+” added, and the opposite direction thereof is described with “−” added.

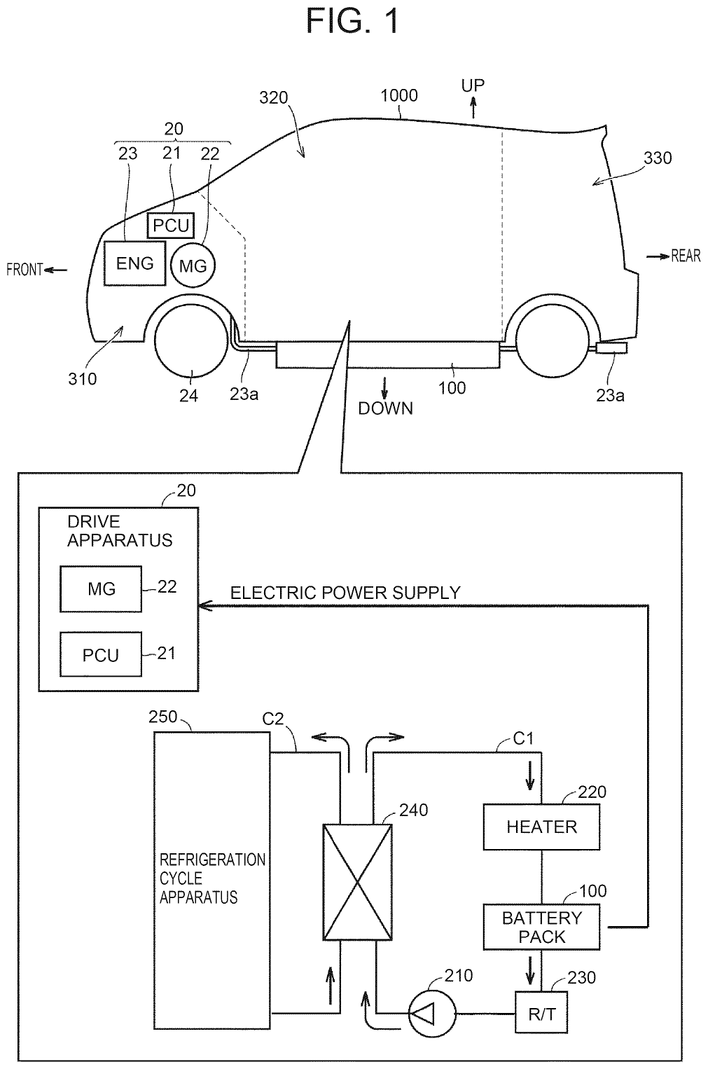

FIG. 1 is a diagram showing the configuration of a vehicle equipped with an electricity storage apparatus according to the embodiment. In FIG. 1, an up-down direction and a front-rear direction that are perpendicular to each other are shown. “Front” corresponds to a traveling direction of the vehicle, and “rear” is the opposite direction thereof. “Down” corresponds to a vertical direction (the direction of gravity), and “up” is the opposite direction thereof.

Referring to FIG. 1, a vehicle 1000 has a front portion 310, a vehicle cabin space 320, and a rear portion 330. The front portion 310 is located in front of the vehicle cabin space 320. The rear portion 330 is located behind the vehicle cabin space 320. A battery pack 100 is provided under a floor of the vehicle 1000. The battery pack 100 is fixed to, for example, a lower face of a floor panel of the vehicle cabin space 320. However, this is not a limitation, and a mounting mode of the battery pack 100 may be any mode. For example, a case of the battery pack 100 may constitute a part of a vehicle body (e.g., the floor panel).

A drive apparatus 20 that drives the vehicle 1000 is provided in the front portion 310 of the vehicle 1000. The front portion 310 is located forward of the center of the vehicle 1000 in the front-rear direction. The drive apparatus 20 includes a power control unit (PCU) 21, a motor generator (MG) 22, and an engine 23. The vehicle 1000 is configured to travel using electric power output from the battery pack 100. The vehicle 1000 is, for example, a plug-in hybrid electric vehicle (PHEV). However, the vehicle 1000 may be another electrified vehicle (xEV). Examples of the electrified vehicle include a hybrid electric vehicle (HEV) and a battery electric vehicle (BEV).

The MG 22 functions as a driving motor and rotates driving wheels 24 of the vehicle 1000. The PCU 21 drives the MG 22 using electric power supplied from the battery pack 100. The PCU 21 includes, for example, an inverter. The MG 22 converts the electric power into torque. The torque is transmitted to the driving wheels 24. In addition, the MG 22 performs regenerative power generation, for example, when the vehicle 1000 decelerates, and charges the battery pack 100.

The engine 23 functions as an internal combustion engine and rotates the driving wheels 24 of the vehicle 1000. The engine 23 generates power by burning fuel supplied from a fuel tank (not shown). The power generated by the engine 23 is transmitted to the driving wheels 24. An exhaust pipe 23a is connected to the engine 23 and discharges exhaust gas of the engine 23 to the outside of the vehicle 1000.

The vehicle 1000 is further equipped with a cooling apparatus that cools the battery pack 100. The cooling apparatus includes refrigerant circuits C1, C2, and a chiller 240. The refrigerant circuit C1 includes a pump 210, a heater 220, and a reserve tank (R/T) 230. The pump 210 circulates a refrigerant through the refrigerant circuit C1. The heater 220 heats the refrigerant flowing through the refrigerant circuit C1 in response to a request from a control device (e.g., an on-board computer, such as an electronic control unit (ECU)), which is not shown. The refrigerant flowing through the refrigerant circuit C1 cools the battery pack 100 when the temperature of the battery pack 100 rises. However, when the temperature of the battery pack 100 is low due to the influence of weather or a location (e.g., a cold climate area), the refrigerant heated by the heater 220 may raise the temperature of the battery pack 100. The refrigerant circuit C2 includes a refrigeration cycle apparatus 250. The refrigeration cycle apparatus 250 includes various devices that perform temperature adjustment in accordance with a refrigeration cycle (that is, a cycle of an evaporation process, a compression process, a condensation process, and an expansion process). A cooling circuit of an air conditioner (not shown) mounted on the vehicle 1000 may constitute the refrigeration cycle apparatus 250. The refrigerant flowing through refrigerant circuit C2 is cooled by the refrigeration cycle apparatus 250. The chiller 240 is connected to the refrigerant circuits C1 and C2, and performs heat exchange between the refrigerant circulating through refrigerant circuit C1 and the refrigerant circulating through refrigerant circuit C2.

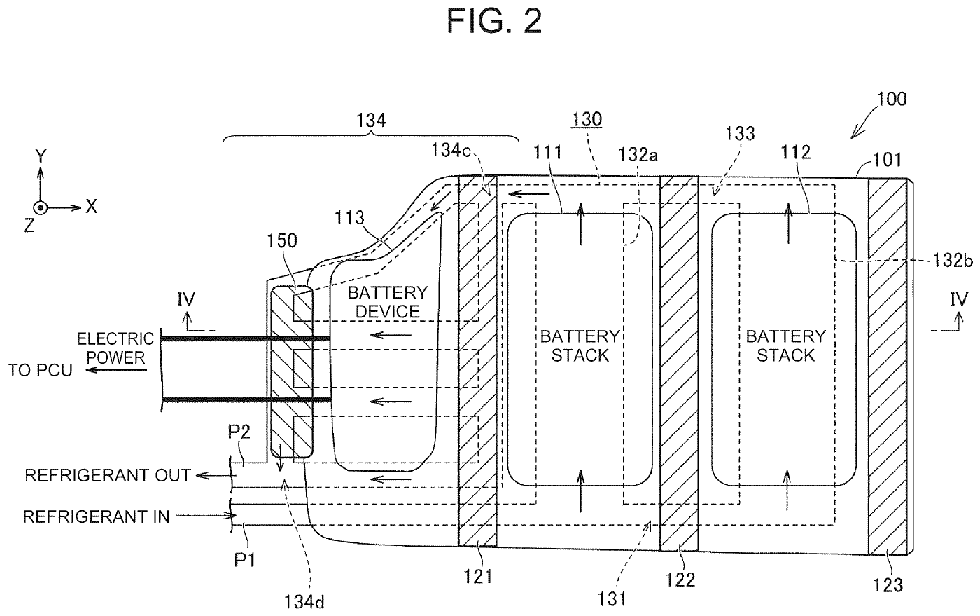

FIG. 2 is a diagram showing the configuration of the battery pack 100. The battery pack 100 shown in FIG. 2 is mounted on the vehicle 1000 such that the −Z-side corresponds to “down” (vertical direction) in FIG. 1, and the −X-side corresponds to “front” in FIG. 1. The battery pack 100 corresponds to an example of the “electricity storage apparatus” according to the present disclosure.

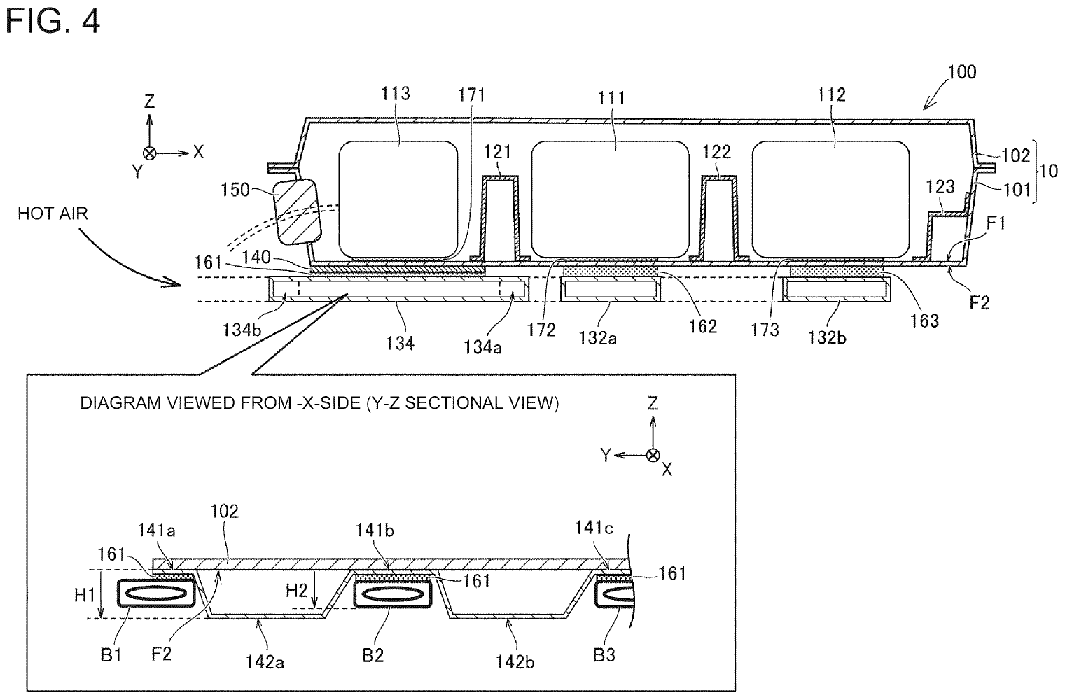

Referring to FIG. 2, the battery pack 100 includes battery stacks 111, 112, a battery device 113, reinforcement members (reinforcements) 121 to 123, a cooling pipe 130, and a connector block 150. In FIG. 2, an upper (UPR) case is omitted, and the configuration inside the case of the battery pack 100 is shown. The contour of a lower (LWR) case 101 shown in FIG. 2 corresponds to the contour of an inner bottom face (a face F1 shown in FIG. 4) of the LWR case 101.

Each of the battery stacks 111, 112 includes a plurality of electricity storage cells (hereinbelow, simply referred to as “cells”) each of which functions as a secondary battery. Each battery stack is, for example, an electricity storage module including a plurality of electrically connected cells that is modularized. In each of the battery stacks 111, 112, the cells are stacked and constrained, for example, in the Y-direction. Examples of the cell include secondary batteries such as a lithium ion battery, a nickel metal hydride battery, and a sodium ion battery. The type of the secondary battery may be a liquid secondary battery or a fully solid-state secondary battery. An exterior body of the cell may be a laminate exterior body or a rectangular case made of metal. Each battery stack may include only cells of the same type or may include cells of different types. Each of the battery stacks 111, 112 corresponds to an example of the “electricity storage element” according to the present disclosure.

The battery device 113 is disposed on the −X-side relative to the battery stacks 111, 112. The battery device 113 includes, for example, a junction box (J/B) that is electrically connected to each of the battery stacks 111, 112. The J/B includes a relay and/or a fuse, and is electrically connected to an external device outside the battery pack 100 (for example, the PCU 21 shown in FIG. 1). When the J/B is in a connected state, electric power output by the battery stacks 111 and 112 is output to the drive apparatus 20 (FIG. 1) through the battery device 113. When J/B is brought into an interrupted state, the supply of electric power from the battery stacks 111, 112 to the drive apparatus 20 (FIG. 1) is interrupted at the battery device 113. However, the battery device 113 may be any electrical device that is housed inside the case of the battery pack 100. For example, the battery device 113 may include at least one of a battery management system (BMS) and a control device (e.g., a battery ECU) instead of or in addition to the J/B. The battery device 113 corresponds to an example of the “electrical device” according to the present disclosure.

Each of the reinforcement members 121 to 123 is long in the Y-direction and fixed (e.g., welded or fastened) to the LWR case 101. Each of the reinforcement members 121 to 123 may be a processed plate-shaped member (e.g., a metal plate-shaped member bent in a U-shape or a stepped shape). The reinforcement member 121 is located between the battery stack 111 and the battery device 113. The battery stack 111 is disposed between the reinforcement members 121 and 122. The battery stack 112 is disposed between the reinforcement members 122 and 123. The reinforcement members 121 to 123 provide collision protection and vibration reduction for the battery stacks 111 and 112.

The cooling pipe 130 is disposed on the −Z-side of each of the battery stacks 111, 112, and the battery device 113 (refer to FIG. 4, which will be described further below). The refrigerant flowing through the cooling pipe 130 cools the battery stacks 111, 112 and the battery device 113. The cooling pipe 130 is broadly divided into an upstream portion that cools the battery stacks 111 and 112 and a downstream portion that cools the battery device 113. Each of the upstream portion and the downstream portion may be formed of metal (e.g., aluminum). The downstream portion includes a device cooling portion 134, and an output port P2 that receives the refrigerant output from the device cooling portion 134. The upstream portion is located upstream of the downstream portion in the cooling pipe 130 (refrigerant channel) and includes an input port P1 to which the refrigerant is input. By connecting the refrigerant circuit C1 shown in FIG. 1 to the input port P1 and the output port P2, the refrigerant can be passed through the cooling pipe 130. The battery stacks 111, 112 and the battery device 113 can be continuously cooled by the pump 210 circulating the refrigerant through the refrigerant circuit C1. The refrigerant may be liquid (e.g., water or an antifreeze solution) or gas (e.g., carbon dioxide).

The upstream portion further includes a lateral channel 131 that is long in the X-direction, longitudinal channels 132a, 132b that are long in the Y-direction, and a lateral channel 133 that is long in the X-direction. The lateral channel 133 is located on the +Y-side relative to the lateral channel 131. The lateral channel 131 and the lateral channel 133 communicate with each other through the longitudinal channels 132a, 132b. The longitudinal channel 132b is located on the +X-side relative to the longitudinal channel 132a. The input port P1 is located at an inlet (−X-side end) of the lateral channel 131. The refrigerant input to the input port P1 flows to the +X-side through the lateral channel 131, flows to the +Y-side through each of the longitudinal channels 132a, 132b, and flows to the −X-side through the lateral channel 133. The refrigerant flowing through the longitudinal channel 132a flows directly under (on the −Z-side of) the battery stack 111 and exchanges heat with the battery stack 111. The refrigerant flowing through the longitudinal channel 132b flows directly under (on the −Z-side of) the battery stack 112 and exchanges heat with the battery stack 112. In the longitudinal channels 132a, 132b, the refrigerant flows to cool the battery stacks 111, 112, respectively. Each of the longitudinal channels 132a, 132b corresponds to an example of the “first portion” according to the present disclosure.

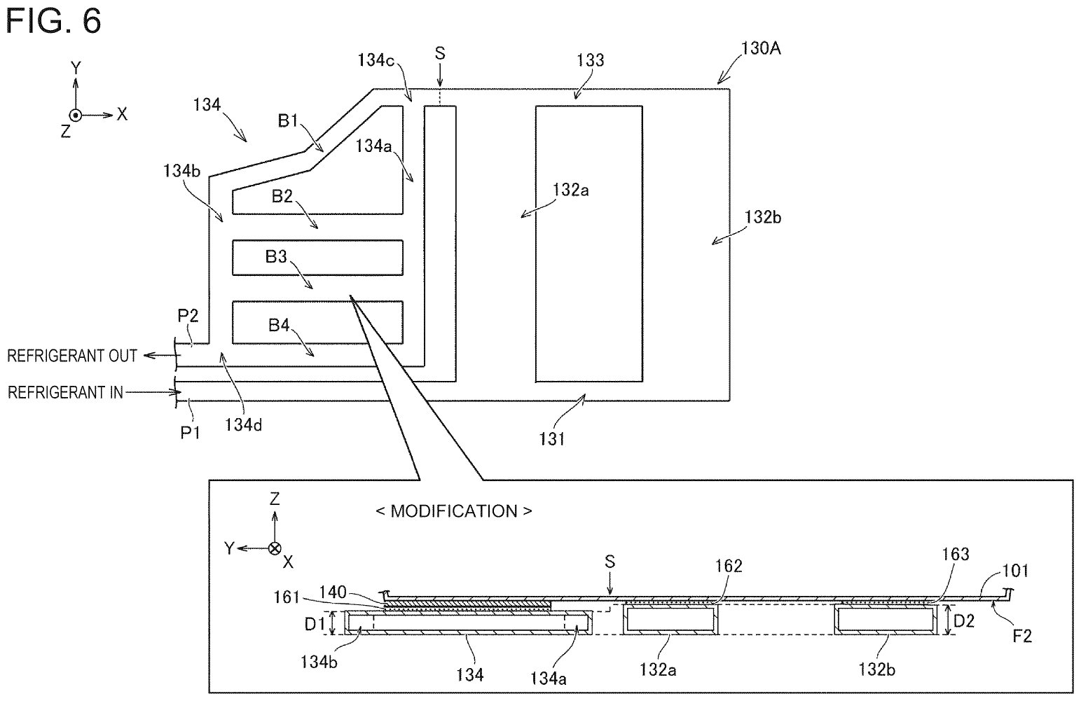

A −X-side end of the lateral channel 133 (an end of the upstream portion) is connected to the downstream portion near a branch end 134c of the device cooling portion 134. In the present embodiment, the upstream portion and the downstream portion of the cooling pipe 130 are integrally molded and seamlessly connected to each other. However, this is not a limitation, and the upstream portion and the downstream portion may be separately molded and then joined together (refer to FIG. 6 which will be described further below).

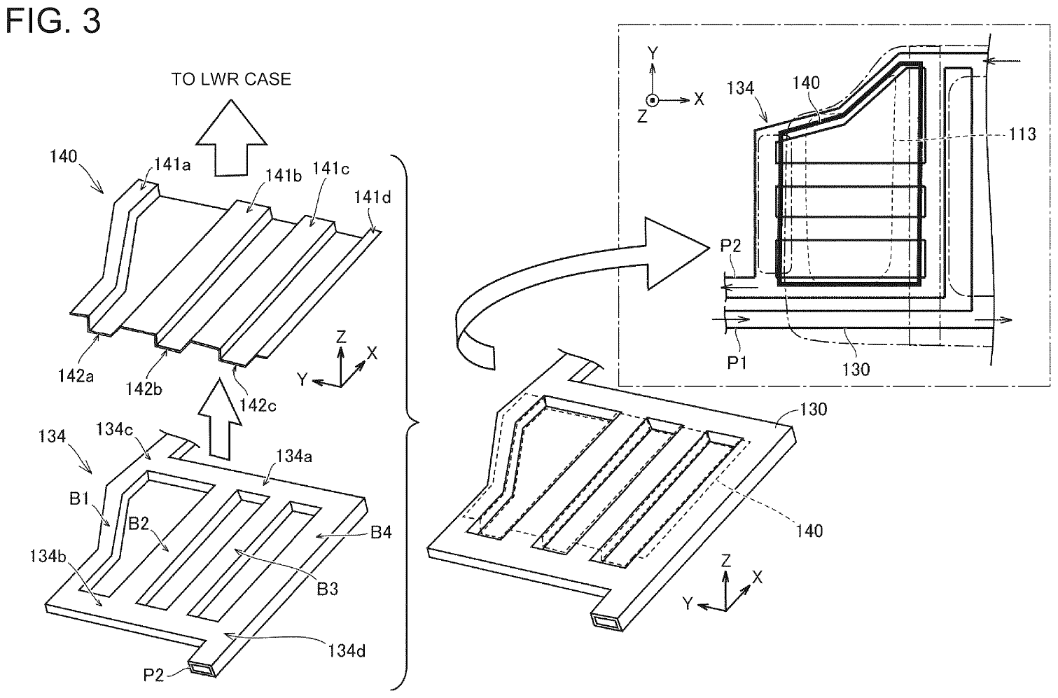

Although not shown in FIG. 2, the battery pack 100 further includes a protection plate that protects the battery device 113. FIG. 3 is a diagram for describing a mode of attachment of the protection plate.

Referring to FIG. 3 together with FIG. 2, a protection plate 140 is provided under (on the −Z-side of) the battery device 113. Furthermore, the device cooling portion 134 of the cooling pipe 130 is provided under (on the −Z-side of) the protection plate 140. The protection plate 140 is disposed between the cooling pipe 130 (in particular, the device cooling portion 134) and the battery device 113. The protection plate 140 protects the battery device 113 from a road surface input and the like. The protection plate 140 acts to reduce vibrations and/or the impact of a front collision in the vehicle 1000 while the vehicle 1000 is traveling. In the embodiment, a bellows cover made of metal (e.g., aluminum) is employed as the protection plate 140.

The device cooling portion 134 includes four channels B1 to B4, a base end channel 134a that is long in the Y-direction, a confluence channel 134b that is long in the Y-direction, a branch end 134c, and a confluence end 134d. The channel from the upstream portion (lateral channel 133) splits into the base end channel 134a and the channel B1 at the branch end 134c. The confluence channel 134b is located on the −X-side relative to the base end channel 134a. The base end channel 134a and the confluence channel 134b communicate with each other through the channels B1 to B4. The channel B1 is located at a +Y-side end of the battery pack 100 and formed along the contour of the battery pack 100. The channel B1 connects a +Y-side end of the base end channel 134a (branch end 134c) to a +Y-side end of the confluence channel 134b. Each of the channels B2 to B4 is long in the X-direction. The channel B4 connects a −Y-side end of the base end channel 134a to a −Y-side end of the confluence channel 134b (confluence end 134d). The confluence channel 134b and the channel B4 meet at the confluence end 134d. The output port P2 is located near the confluence end 134d (on the −X-side of the confluence end 134d).

In the device cooling portion 134, the base end channel 134a splits into the channels B1 to B4, and the channels B1 to B4 meet at the confluence channel 134b. The refrigerant flowing through each of the channels B1 to B4 flows directly under (on the −Z-side of) the battery device 113 and exchanges heat with the battery device 113. In each of the channels B1 to B4, the refrigerant flows to cool the battery device 113 (e.g., a copper plate of the J/B). The channels B1 to B4 correspond to an example of the “plurality of channels” according to the present disclosure. Each of the channels B1 to B4 corresponds to an example of the “second portion” according to the present disclosure. The confluence channel 134b corresponds to an example of the “confluence portion” according to the present disclosure.

The protection plate 140 is formed in a bellows shape, and has base end portions 141a to 141d and projections 142a to 142c. The plurality of projections formed on the protection plate 140 facilitates increasing the rigidity of the protection plate 140. The base end portions 141a to 141d are formed at the same height (the same position in the Z-direction). Each of the projections 142a to 142c projects toward the −Z-side relative to the base end portions 141a to 141d. The projection 142a is, for example, a ridge having a shape corresponding to a clearance between the channels B1, B2 of the cooling pipe 130 from a first end to a second end of the protection plate 140 in the X-direction. The projection 142b is, for example, a ridge having a shape corresponding to a clearance between the channels B2, B3 of the cooling pipe 130 from the first end to the second end of the protection plate 140 in the X-direction. The projection 142c is, for example, a ridge having a shape corresponding to a clearance between the channels B3, B4 of the cooling pipe 130 from the first end to the second end of the protection plate 140 in the X-direction. The protection plate 140 is attached to the cooling pipe 130 such that the projection 142a is inserted between the channels B1, B2, the projection 142b is inserted between the channels B2, B3, and the projection 142c is inserted between the channels B3, B4. The cooling pipe 130 is then attached to the LWR case 101 of the battery pack 100 through the protection plate 140.

FIG. 4 is a sectional view taken along line IV-IV in FIG. 2. Referring to FIG. 4, the battery pack 100 includes a case 10. The case 10 includes the LWR case 101 and the UPR case 102. The battery stacks 111, 112 and the battery device 113 are housed in the case 10. The LWR case 101 has faces F1, F2. The face F1 corresponds to an inner face (+Z-side face) of a bottom of the LWR case 101. The face F2 corresponds to an outer face (−Z-side face) of the bottom of the LWR case 101. Each of the reinforcement members 121 to 123 is fixed to the face F1 and reinforces the bottom of the LWR case 101. In addition, the battery device 113, the battery stack 111, and the battery stack 112 are connected to the face F1 of the LWR case 101 through thermally conductive materials 171, 172, 173, respectively. In the embodiment, each of the thermally conductive materials 171 to 173 functions as an adhesive. The adhesion of the thermally conductive materials 171 to 173 connects (bonds) the battery stacks 111, 112 and the battery device 113 to the face F1 of the LWR case 101.

The connector block 150 is provided at an opening formed in a −X-side face of the LWR case 101. The connector block 150 is, for example, an aluminum block formed by die casting (casting method). A part of the connector block 150 is located outside the case 10. The connector block 150 may be fastened to the LWR case 101 or may be fixed to the LWR case 101 by another method (welding, an adhesive, etc.). An electric wire that connects the battery device 113 inside the case 10 to the external device (e.g., the PCU 21) penetrates the connector block 150. Such a structure enables exchange of electric power between the components inside the case 10 (e.g., the battery stacks 111, 112) and the external device.

In the cooling pipe 130 shown in FIG. 2, the longitudinal channels 132a, 132b are connected to the face F2 of the LWR case 101 through thermally conductive materials 162, 163, respectively. In the embodiment, each of the thermally conductive materials 162, 163 functions as an adhesive. The adhesion of the thermally conductive materials 162, 163 connects (bonds) the longitudinal channels 132a, 132b to the face F2 of the LWR case 101.

The protection plate 140 is connected to the −Z-side of the LWR case 101. More specifically, each of the base end portions 141a to 141d of the protection plate 140 is welded to the face F2 of the LWR case 101. The base end channel 134a of the device cooling portion 134 is located under (on the −Z-side of) the reinforcement member 121. A flange of the reinforcement member 121 is located above (on the +Z-side of) the protection plate 140. In an area where the LWR case 101, the protection plate 140, and the reinforcement member 121 overlap in three layers, the LWR case 101, the protection plate 140, and the reinforcement member 121 may be collectively welded together. Such three-layer welding increases joining strength and rigidity. Each of the projections 142a to 142c of the protection plate 140 projects to the −Z-side from the face F2 of the LWR case 101 (the connected face between the case 10 and the protection plate 140).

The device cooling portion 134 of the cooling pipe 130 (in particular, the channels B1 to B4) is connected to the −Z-side of the protection plate 140 through a thermally conductive material 161. More specifically, the channels B1, B2, B3, B4 are connected to the base end portions 141a, 141b, 141c, 141d (hat portions), respectively, through the thermally conductive material 161. In the embodiment, the thermally conductive material 161 functions as an adhesive. The adhesion of the thermally conductive material 161 connects (bonds) the channels B1 to B4 to −Z-side faces of the base end portions 141a to 141d. As shown in the Y-Z sectional view of the device cooling portion 134 (diagram viewed from the −X-side) in FIG. 4, the channel B2 is disposed between the projection 142a and the projection 142b. In addition, the channel B3 is disposed between the projection 142b and the projection 142c (refer to FIG. 3). Each of the projections 142a to 142c projects toward the −Z-side relative to the device cooling portion 134 (including the channels B1 to B4). More specifically, the distance H1 from the face F2 to a −Z-side end face (tip face) of each of the projections 142a to 142c is larger than the distance H2 from face F2 to a −Z-side end face (lower face) of each of the channels B1 to B4.

As described above, since the protection plate 140 has the projections, when an impact is input to the protection plate 140 from the −Z-side, deformation of the projections facilitates absorption of impact energy. Furthermore, the presence of the projections of the protection plate 140 leaves a clearance (air layer) between the protection plate 140 and the case 10 (LWR case 101). Thus, even if the protection plate 140 is exposed to heat, the heat is unlikely to be transferred to the inside of the case 10. In addition, since each of the projections 142a to 142c projects beyond the cooling pipe 130, the cooling pipe 130 is protected by the projections 142a to 142c.

In the embodiment, the protection plate 140 is made of metal and has high thermal conductivity. This increases the thermal conductivity between the cooling pipe 130 and the battery device 113. In addition, since the cooling pipe 130 is disposed in a space (recess) between the projections of the protection plate 140, it is easy to dispose the protection plate 140 and the cooling pipe 130 near the battery device 113. This facilitates heat exchange between the cooling pipe 130 and the battery device 113. In addition, the presence of the thermally conductive materials also facilitates the heat exchange.

Each of the thermally conductive materials 161 to 163, 171 to 173 has a higher thermal conductivity than air (air gap). In the embodiment, a silicone-based adhesive is used as each of the thermally conductive materials 161 to 163, 171 to 173. However, the type of each thermally conductive material may be any type and is not limited to an adhesive. Instead of bonding, the thermally conductive material may be connected by another method (e.g., welding). In addition, the thermally conductive material is not an essential configuration and may be omitted.

In the vehicle 1000 (FIG. 1), each of the MG 22 (driving motor), the engine 23 (internal combustion engine), and the exhaust pipe 23a that are disposed in the front portion 310 serves as a heat source. In the cooling pipe 130 installed in the vehicle 1000, the confluence channel 134b of the device cooling portion 134 is located between the channels B1 to B4 of the device cooling portion 134 and the front portion 310 of the vehicle 1000 (including the heat sources described above). More specifically, the confluence channel 134b is located under (on the −Z-side of) the connector block 150. In the vehicle 1000, the confluence channel 134b (the confluence portion) blocks hot air from the heat sources. This makes it possible to restrain the temperature of the refrigerant (and, in turn, the temperature of the battery device 113) from being raised by the hot air.

In addition, in electrified vehicles, the electricity storage elements (e.g., the battery stacks 111, 112) tend to require thermal management with higher accuracy than the electrical device (e.g., the battery device 113). In this regard, in the cooling pipe 130, as shown in FIG. 2, the first portion (e.g., the longitudinal channels 132a, 132b) through which the refrigerant flows to cool the electricity storage elements is located upstream of the second portion (e.g., the channels B1 to B4) through which the refrigerant flows to cool the electrical device. With such a configuration, the electricity storage elements are cooled first, and the electrical device is cooled later. Thus, it is conceivable that even when the temperature of the refrigerant is raised by cooling the electrical device, the influence on cooling of the electricity storage elements is small (or there is no influence). The configuration described above facilitates appropriate cooling of the electricity storage elements and the electrical device.

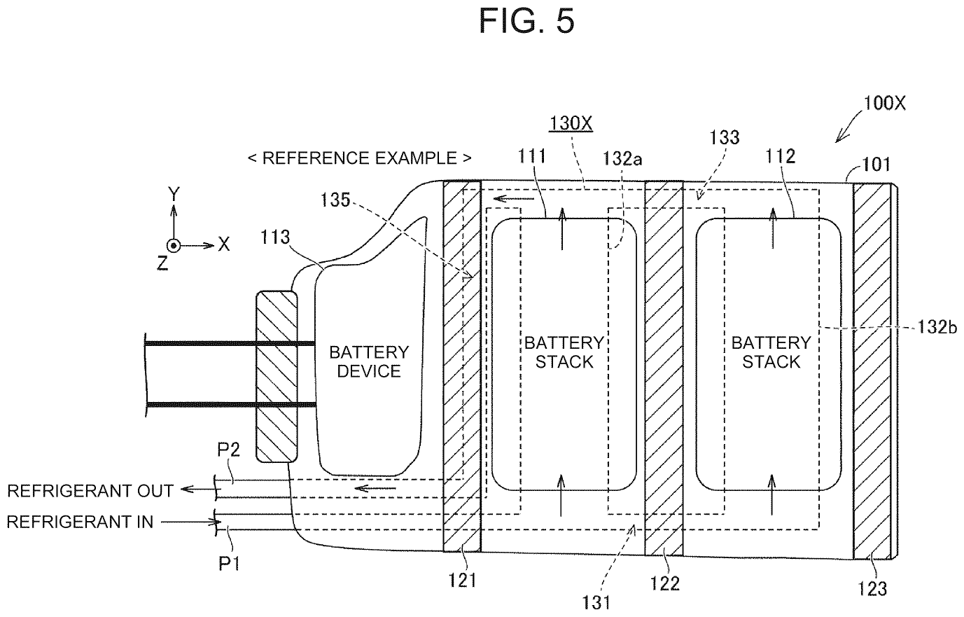

FIG. 5 is a diagram for describing the actions and effects of the electricity storage apparatus (battery pack 100) according to the embodiment. The battery pack 100 described above includes the protection plate 140. However, an electricity storage apparatus including no protection plate for the battery device can also be used in the vehicle. FIG. 5 shows an example of the electricity storage apparatus including no protection plate as a reference example.

Referring to FIG. 5, a battery pack 100X according to the reference example includes no protection plate. In addition, the battery pack 100X includes a cooling pipe 130X instead of the cooling pipe 130 (FIG. 2). The cooling pipe 130X includes a channel 135 instead of the device cooling portion 134 (FIG. 2). The channel 135 provides communication between the lateral channel 133 and the output port P2. The channel 135 is provided avoiding the battery device 113. In the battery pack 100X, heat dissipation of the battery device 113 restrains the temperature of the battery device 113 from excessively rising.

However, when the battery pack 100X is mounted on the vehicle, the battery device 113 (the electrical device inside the case) is susceptible to a road surface input. Thus, a protection plate for the battery device 113 may be added to the battery pack 100X. In the battery pack 100X, since the channel 135 is provided avoiding the battery device 113, it is easy to add the protection plate for the battery device 113. However, providing the protection plate may disadvantageously reduce the heat dissipation of the battery device 113. When the temperature of the battery device 113 rises and approaches an allowable temperature, the ECU or the BMS may limit input and output currents of the battery stacks 111, 112 (electricity storage elements). Such limitation may reduce the electricity efficiency or the fuel efficiency of the vehicle or increase the charging time of the battery stacks 111, 112.

In this regard, in the battery pack 100 described above, the protection plate 140 is disposed between the cooling pipe 130 (the device cooling portion 134) and the battery device 113 as shown in FIG. 4. In the battery pack 100 having such a configuration, the protection plate 140 can protect the battery device 113. In addition, the device cooling portion 134 can exchange heat with the battery device 113 through the protection plate 140. This makes it possible to achieve both protection and cooling of the battery pack 100 (in particular, the electrical device inside the case 10).

The cooling pipe 130 may be manufactured by joining an upstream portion and a downstream portion that are separately formed. FIG. 6 is a diagram showing a modification of the cooling pipe shown in FIG. 2. Referring to FIG. 6, in a cooling pipe 130A according to the modification, the upstream portion (including the longitudinal channels 132a, 132b) and the downstream portion (including the device cooling portion 134) are connected (e.g., welded) at a connected portion S. With the cooling pipe 130A having such a configuration, it is easy to change the upstream portion or the downstream portion.

A plurality of types of cooling pipes may be manufactured using a common upstream portion. For example, a manufacturing apparatus may select the downstream portion shown in FIG. 2 (including the device cooling portion 134) or the downstream portion shown in FIG. 5 (including the channel 135) in accordance with the vehicle type. The manufacturing apparatus may connect the selected downstream portion to the upstream portion.

As shown in the lower part (Y-Z sectional view) in FIG. 6, the thickness of the channel may differ between the upstream portion and the downstream portion. In the modification shown in FIG. 6, the thickness of the downstream portion (dimension D1) is smaller than the thickness of the upstream portion (dimension D2). The difference between the dimension D1 and the dimension D2 may be equal to the thickness of the protection plate 140. This enables the thermally conductive materials 161 to 163 to have the same thickness. The material of the upstream portion and the material of the downstream portion may be the same as each other or may differ from each other.

In the embodiment described above, the battery device 113, the device cooling portion 134, and the protection plate 140 are disposed on the −X-side (front side) relative to the center of the battery pack 100 in the X-direction (refer to FIGS. 2 and 3). However, this is not a limitation, and the battery device 113, the device cooling portion 134, and the protection plate 140 may be disposed on the +X-side (rear side) relative to the center of the battery pack 100 in the X-direction.

The vehicle is not limited to a passenger car, and may be a bus, a truck, a work vehicle (e.g., a tractor or a forklift), or an automated guided vehicle (AGV).

The various features (the features described in the embodiment and the modification) relating to the electricity storage apparatus described above may be implemented in any combination. The electricity storage apparatus may be applied to apparatuses other than vehicles.

It should be understood that the embodiment disclosed herein is illustrative and not restrictive in all respects. The scope of the disclosure is defined not by the description of the embodiment, but by the claims, and intended to include all changes within the meaning and scope equivalent to the claims.

What is claimed is:

1. An electricity storage apparatus comprising:
a case; and
an electricity storage element and an electrical device that are housed in the case, wherein:
the case is provided with a protection plate that protects the electrical device;
the electricity storage apparatus further comprises a cooling pipe that cools the electricity storage apparatus; and
the protection plate is disposed between at least a part of the cooling pipe and the electrical device.

2. The electricity storage apparatus according to claim 1, wherein:
the protection plate is connected to the case;
the protection plate has a plurality of projections projecting from a connected face between the case and the protection plate; and
the cooling pipe has a portion disposed between two projections included in the projections.

3. The electricity storage apparatus according to claim 2, wherein:
the protection plate is a plate made of metal;
the cooling pipe is connected to the protection plate through a thermally conductive material; and
each of the two projections projects beyond the cooling pipe.

4. The electricity storage apparatus according to claim 1, wherein:
the cooling pipe includes a first portion through which a refrigerant flows to cool the electricity storage element, and a second portion through which the refrigerant flows to cool the electrical device; and
the first portion is located upstream of the second portion.

5. A vehicle comprising:
the electricity storage apparatus according to claim 1; and
a heat source, wherein:
the electricity storage apparatus is disposed under a floor of the vehicle;
the heat source includes at least one of a driving motor, an internal combustion engine, and an exhaust pipe;
the cooling pipe includes a plurality of channels through which a refrigerant flows to cool the electrical device, and a confluence portion at which the channels meet; and
the confluence portion is located between the channels and the heat source.
